(19) United States
(12) Patent Application Publication
(10) Pub. No.: US 2020/0147932 A1
(43) Pub. Date: May 14, 2020

(54) BENDABLE LAMINATED ARTICLE INCLUDING ANISOTROPIC LAYER

(71) Applicant: CORNING INCORPORATED, CORNING, NY (US)

(72) Inventors: Shinu Baby, Painted Post, NY (US); Dhananjay Joshi, Painted Post, NY (US); Inna Igorevna Kouzmina, Corning, NY (US); Yousef Kayed Qaroush, Painted Post, NY (US); Arlin Lee Weikel, Mansfield, PA (US)

(21) Appl. No.: 16/620,360

(22) PCT Filed: Jun. 1, 2018
(86) PCT No.: PCT/US2018/035560

§ 371 Date: Dec. 6, 2019

Related U.S. Application Data
(60) Provisional application No. 62/517,517, filed on Jun. 9, 2017.

(51) Int. Cl. B32B 17/10; B32B 7/06

(52) U.S. Cl. CPC B32B 17/10018; B32B 7/06

(57) ABSTRACT

A laminated glass article including a base layer, an anisotropic layer disposed over a top surface of the base layer, and a glass layer disposed over the anisotropic layer. The anisotropic layer may include homogeneous mechanical anisotropic properties measured at intervals of 250 microns. In some embodiments, the anisotropic layer may be an orthotropic layer including homogeneous mechanical orthotropic properties measured at intervals of 250 microns. The homogenous mechanical anisotropic or orthotropic properties of the anisotropic layer may provide a flexible laminated glass article with a high resistance to impact and puncture forces. In some embodiments, the laminated glass article may define all or a portion of a cover substrate for a consumer product.

### CROSS-REFERENCE TO RELATED APPLICATION

This application claims the benefit of priority under 35 U.S.C. §119 of U.S. Provisional Application Ser. No. 62/517,517 filed on Jun. 9, 2017, the content of which is relied upon and incorporated herein by reference in its entirety.

### BACKGROUND

### Field

The present disclosure relates to laminated cover substrates including an anisotropic layer. In particular, the present disclosure relates to cover substrates including an anisotropic layer having homogenous mechanical properties that increase the puncture or impact resistance of the cover substrates.

### Background

A cover substrate for a display of an electronic device protects a display screen and provides an optically transparent surface through which a user can view the display screen. Recent advancements in electronic devices (e.g., handheld and wearable devices) are trending towards lighter devices with improved reliability. The weight of different components of these devices, including protective components, such as cover substrates, have been reduced to create lighter devices.

Further, flexible cover substrates have been developed to compliment flexible and foldable display screens. However, when increasing the flexibility of a cover substrate, other characteristics of the cover substrate may be sacrificed. For example, increasing flexibility may in some situations, among other things, increase weight, reduce optical transparency, reduce scratch resistance, reduce puncture resistance, and/or reduce thermal durability.

Plastic films may have good flexibility but suffer from poor mechanical durability. Polymer films with hard coatings have shown improved mechanical durability but often result in higher manufacturing costs and reduced flexibility. Thin monolithic glass solutions have excellent scratch resistance, but meeting the flexibility and puncture resistance metrics at the same time has been a challenge. Ultrathin glass (<50 μm) can form tight curvature but suffers from reduced puncture resistance and thicker glass (>80 μm) may have a better puncture resistance but suffers from a limited bending radius.

Currently several approaches are being pursued to address these problems with various degrees of success. One approach includes a laminated polymer/ultra-thin glass stack to improve puncture resistance. A second approach includes stacked ultra-thin glass layers with anti-friction interlayers. A third approach includes pre-stressing a glass internally through ion-exchange induced stresses to improve the bendability. A fourth approach includes a woven glass fiber/polymer composite with a glass fiber core and hard polymer coatings.

Therefore, a continuing need exists for innovations in cover substrates for consumer products, such as cover substrates for protecting a display screen. And in particular, cover substrates for consumer devices including a flexible component, such as a flexible display screen.

### BRIEF SUMMARY

The present disclosure is directed to cover substrates, for example flexible cover substrates for protecting a flexible or sharply curved component, such as a display component, including an interlayer that does not negatively affect the flexibility or curvature of the component while also protecting the component from damaging mechanical forces. The flexible cover substrate may include a flexible glass layer for providing scratch resistance and an anisotropic or orthotropic interlayer for providing impact and/or puncture resistance.

Some embodiments are directed towards a laminated glass article including a base layer, for example flexible base layer, having a top surface and a bottom surface; an anisotropic layer disposed over the top surface of the base layer, the anisotropic layer including homogeneous mechanical anisotropic properties measured at intervals of 250 micrometers (microns, μm); and a glass layer, for example a thin glass layer, disposed over the anisotropic layer, where the homogeneous mechanical anisotropic properties of the anisotropic layer include: a first elastic modulus measured in a first direction parallel to the top surface of the base layer, a second elastic modulus measured in a second direction parallel to the top surface of the base layer and perpendicular to the first direction, and a third elastic modulus measured in a third direction orthogonal to the top surface of the base layer, the third elastic modulus being 100 or more times larger than each of the first elastic modulus and the second elastic modulus.

Some embodiments are directed towards a method of making a laminated glass article, the method including disposing an anisotropic layer over a top surface of a base layer, for example a flexible base layer, the anisotropic layer including homogeneous mechanical anisotropic properties measured at intervals of 250 microns; and disposing a glass layer, for example a thin glass layer, over the anisotropic layer, where the homogeneous mechanical anisotropic properties of the anisotropic layer include a first elastic modulus measured in a first direction parallel to the top surface of the base layer, a second elastic modulus measured in a second direction parallel to the top surface of the base layer and perpendicular to the first direction, and a third elastic modulus measured in a third direction orthogonal to the top surface of the base layer, the third elastic modulus being 100 or more times larger than each of the first elastic modulus and the second elastic modulus.

Some embodiments are directed towards an article including a cover substrate including a base layer, for example a flexible base layer, including a top surface and a bottom surface; an anisotropic layer disposed over the top surface of the base layer, the anisotropic layer including homogeneous mechanical anisotropic properties measured at intervals of 250 microns; and a glass layer, for example a thin glass layer disposed over the anisotropic layer, where the homogeneous mechanical anisotropic properties of the anisotropic layer include: a first elastic modulus measured in a first direction parallel to the top surface of the base layer, a second elastic modulus measured in a second direction parallel to the top surface of the base layer and perpendicular to the first direction, and a third elastic modulus measured in a third direction orthogonal to the top surface of the base layer, the third elastic modulus being 100 or more times larger than the first elastic modulus and the second elastic modulus.

In some embodiments, the article according to the embodiments of the preceding paragraph may be a consumer electronic product including a housing having a front surface, a back surface and side surfaces; electrical components at least partially within the housing, the electrical components including at least a controller, a memory, and a display, the display at or adjacent the front surface of the housing; and the cover substrate, the cover substrate being disposed over the display or being a portion of the housing.

In some embodiments, the laminated glass article according to the embodiments of any of the preceding paragraphs may include an anisotropic layer including homogeneous orthotropic mechanical properties, where the first elastic modulus is equal to the second elastic modulus +/−1%.

In some embodiments, the embodiments of any of the preceding paragraphs may further include a glass layer that has a thickness in the range of 125 microns to 1 micron.

In some embodiments, the embodiments of any of the preceding paragraphs may include an anisotropic layer having a thickness in the range of 75 microns to 25 microns.

In some embodiments, in the embodiments of any of the preceding paragraphs a difference between a refractive index of the base layer and a refractive index of the anisotropic layer may be less than or equal to 0.05.

In some embodiments, in the embodiments of any of the preceding paragraphs the laminated glass article may have a bend radius of 10 millimeters or less.

In some embodiments, in the embodiments of any of the preceding paragraphs, the anisotropic layer may include a plurality of stacked sub-layers.

In some embodiments, in the embodiments of any of the preceding paragraphs, the anisotropic layer may include a micro-structured film encapsulated by an adhesive. In some embodiments, the micro-structured film may include a plurality of surface features disposed on a surface of the micro-structured film. In some embodiments, the surface features may be micro-features having at least one dimension of 100 microns or less, the dimension being measured in a direction parallel to the top surface of a base layer. In some embodiments, the adhesive may include a pressure sensitive adhesive.

In some embodiments, in the embodiments of any of the preceding paragraphs, the base layer may include a flexible base layer having a bend radius less than or equal to 10 millimeters.

In some embodiments, in the embodiments of any of the preceding paragraphs, the anisotropic layer may include a polymeric material.

In some embodiments, in the embodiments of any of the preceding paragraphs, the anisotropic layer may include a composite polymeric material.

In some embodiments, in the embodiments of any of the preceding paragraphs, the anisotropic layer may include a tentered material.

In some embodiments, in the embodiments of any of the preceding paragraphs, the anisotropic layer may include a self-assembled molecular assembly including patterned features, where the patterned features have a least one dimension of 100 microns or less measured in a direction parallel to the top surface of a base layer.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates a laminated glass article according to some embodiments.

FIG. 2 is a graph of force vs. deflection of four glass laminates under static indentation testing.

FIG. 3 is a graph of the maximum principle stress vs. load on the inner surface of a glass layer in four glass laminates under static indentation testing.

FIG. 4 illustrates a schematic of a model created to simulate the two-point bend test of foldable glass laminates.

FIG. 5 is a graph of normal stress in glasses laminates as function of thickness of glass laminates under a two-point bend test.

FIG. 6 is a graph of bend force vs. plate separation for glass laminates under a two-point bend test.

FIG. 7 illustrates a laminated glass article comprising a micro-structured film according to some embodiments.

FIG. 8 shows scanning electron microscope (SEM) images of honeycomb micro-structured films according to some embodiments.

FIG. 9 illustrates an anisotropic layer divided into measurement intervals according to some embodiments.

FIG. 10 illustrates a consumer product according to some embodiments.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Cover substrates for consumer products, for example cover glass, may serve to, among other things, reduce undesired reflections, prevent formation of mechanical defects in the glass (e.g., scratches or cracks), and/or provide an easy to clean transparent surface. The cover substrates disclosed herein may be incorporated into another article such as an article with a display (or display articles) (e.g., consumer electronic products, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance, or a combination thereof. An exemplary article incorporating any of the laminated glass articles disclosed herein is a consumer electronic device including a housing having front, back, and side surfaces; electrical components that are at least partially inside or entirely within the housing and including at least a controller, a memory, and a display at or adjacent to the front surface of the housing; and a cover substrate at or over the front surface of the housing such that it is over the display. In some embodiments, the cover substrate may include any of the laminated glass articles disclosed herein. In some embodiments, at least one of a portion of the housing or the cover substrate comprises a laminated glass article disclosed herein.

Cover substrates, such as cover glasses, serve to protect sensitive components of a consumer product from mechanical damage (e.g., puncture and impact forces). For consumer products including a flexible, foldable, and/or sharply curved portion (e.g., a flexible, foldable, and/or sharply curved display screen), a cover substrate for protecting the display screen should preserve the flexibility, foldability, and/or curvature of the screen while also protecting the screen. Moreover, the cover substrate should resist mechanical damage, such as scratches and fracturing, so that a user can enjoy an unobstructed view of the display screen.

Thick monolithic glass substrates may provide adequate mechanical properties, but these substrates can be bulky and incapable of folding to tighter radii in order to be utilized in foldable, flexible, or sharply curved consumer products. And highly flexible cover substrates, such a plastic substrates, may be unable to provide adequate puncture resistance, scratch resistance, and/or fracture resistance desirable for consumer products.

In some embodiments, cover substrates discussed herein may include a laminated glass article with an interlayer designed to improve impact reliability during impact loading due to an elastic modulus in the out-of-plane direction of the laminated glass article (i.e., perpendicular to an outer surface of the laminated glass article). And at the same time, the interlayer may allow bending during a folding process due to low elastic moduli in the in-plane directions of the laminated glass article (i.e., directions parallel to the outer surface of the laminated glass article).

The laminated glass articles discussed herein improve bendable display device performance by providing an engineered interlayer material having anisotropic or orthotropic behavior when subject to impact or puncture forces while retaining bendability. In some embodiments, anisotropic or orthotropic behavior can be achieved by engineering, for example, inclusions and/or stiffening members in the material. By engineering the anisotropic or orthotropic material properties of an interlayer, the following benefits may be realized. First, the reliability (e.g., impact resistance, puncture resistance, and/or fracture resistance) of a bendable cover substrate may be increased. Second a bendable cover substrate with low bending forces may be achieved. Third, a thinner cover substrate may be achieved without sacrificing reliability. Fourth, the first three benefits may be achieved without increasing cost, or at lower cost. In embodiments including a thin glass layer, or ultra-thin glass layer, the combination of a thin glass layer and an engineered interlayer material having anisotropic or orthotropic behavior with discrete island structures may, together, create a structure that offers good puncture resistance performance that a thin glass layer alone can't achieve, but that also preserves the flexibility of the thin glass layer.

In some embodiments, the engineered interlayer may be an anisotropic layer having homogenous mechanical properties that structurally reinforce a laminated glass article to improve mechanical reliability while also retaining desired flexibility. In some embodiments, the engineered interlayer may be an orthotropic layer having homogenous mechanical properties that structurally reinforce a laminated glass article to improve mechanical reliability while also retaining desired flexibility.

As used herein, “homogeneous” generally means independent of position. So, a material with a homogeneous structure would have the same structure at all positions. A material with a particular property that is homogeneous would have that same property at all positions. Homogeneity depends on scale—materials or properties that are homogeneous when measured or viewed with low resolution may be inhomogeneous when viewed at higher resolution. For example, a material having two distinct types of grains with distinct properties may appear homogeneous when measured on a scale significantly larger than the grain size, but inhomogeneous when measured on a scale smaller than the grain size.

As used herein, “isotropic” generally means independent of direction. “Anisotropic” means dependent on direction. A material with a particular property that is isotropic at a particular point would have that same property regardless of measurement direction. For example, if Young's modulus is isotropic at a point, the value of the Young's modulus is the same regardless of the stretching direction used to measure Young's modulus. Any combination of homogeneity and isotropy is possible: homogeneous and isotropic, homogeneous and anisotropic, inhomogeneous and isotropic, or inhomogeneous and anisotropic. For example, a material may have a homogeneous anisotropic property. Because the property is homogeneous, it would be the same at every point in the material. But, because the property is anisotropic, it would have some variability based on direction. This variability in direction would be the same at every point in the material.

As used herein, “mechanical properties” refers to the stiffness matrix of a material, and properties that may be derived from the stiffness matrix. Young's or elastic modulus (E), Poisson's ratio (v) and shear modulus (G), which may or may not depend on direction at a particular point, are examples of such properties. An isotropic material has 2 independent elastic constants, often expressed as the Young's modulus and Poison's ratio of the material (although other ways to express may be used), which do not depend on position in such a material. A fully anisotropic material has 21 independent elastic constants. An orthotropic material has 9 independent elastic constants.

As used herein, “homogeneous mechanical properties” means a material having a set of mechanical properties that are constant when measured at intervals of X microns, for example 250 microns or 300 microns. In other words, if a material with “homogeneous mechanical properties” was divided into elements having a surface area of X square microns, each element would have substantially the same values for a certain set of material properties (e.g., elastic modulus properties). For example, a material having homogeneous mechanical properties due to microstructure might have microfeatures with relevant dimensions equal to or less than 100 microns, such that the number of microfeatures present in each 250 square micron measurement interval is sufficient to make any differences between different measurement intervals small. For example, one measurement interval would not fall mostly in a space between microfeatures, while another measurement interval includes mostly microfeatures as opposed to space between microfeatures.

In some embodiments, a material having “homogeneous mechanical properties” may have homogeneous mechanical anisotropic properties. In some embodiments, a material having “homogeneous mechanical properties” may have homogeneous mechanical orthotropic properties. In contrast to an isotropic material, the mechanical properties of anisotropic and orthotropic materials differ in different directions. Orthotropic materials are a sub-set of anisotropic materials. By definition, an orthotropic material has at least two orthogonal planes of symmetry where material properties are independent of direction within each plane. An orthotropic material has nine independent variables (i.e. elastic constants) in its stiffness matrix. An anisotropic material can have up 21 elastic constants to define its stiffness matrix, if the material completely lacks planes of symmetry. A plane of symmetry is a plane in the material where material properties are independent of direction.

A material having homogenous mechanical properties measured at an interval of 250 microns may have a homogenous material structure or an inhomogeneous material structure when evaluated at an interval less than 250 microns, such a 100 microns. Different from homogeneous mechanical properties, a homogeneous or inhomogeneous material structure does not depend on the direction in which the structure is evaluated. A homogenous structure may be homogenous in all directions. And an inhomogeneous structure may be inhomogeneous in all directions.

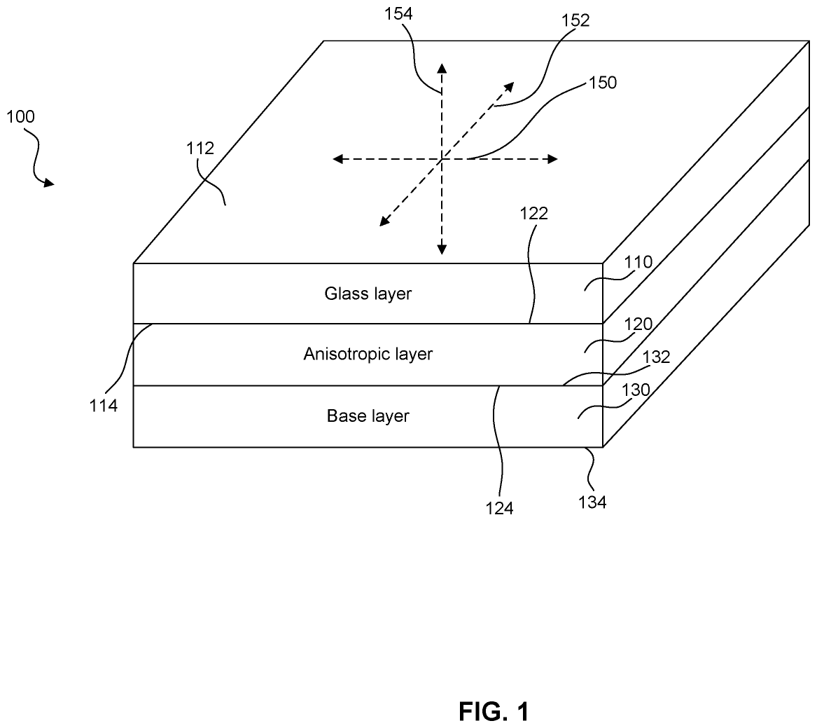

FIG. 1 illustrates a laminated glass article 100 according to some embodiments. Laminated glass article 100 may include a glass layer 110, an anisotropic layer 120, and a base layer 130. In some embodiments, base layer 130 may be a flexible base layer having a bend radius less than or equal to 10 millimeters (mm). In some embodiments, the bend radius of base layer 130 may be in the range of 10 mm to 1.0 mm, in the range of 5.0 mm to 1.0 mm, or in the range of 3.0 mm to 1.0 mm. In some embodiments, base layer 130 may be a rigid base layer. In some embodiments, base layer 130 may comprise glass. In some embodiments, base layer 130 may comprise a polymeric material. Suitable polymeric materials for base layer 130 include, but are not limited to, polyethylene terephthalate (PET), polyimide and polycarbonates (PC).

In some embodiments, base layer 130 may be a component of a display unit. For example, in some embodiments, base layer 130 may be an organic light emitting diode (OLED) display screen or a light emitting diode (LED) display screen. In some embodiments, base layer 130 may be an AMOLED (active-matrix organic light-emitting diode) display screen. In such embodiments, the AMOLED display screen may include two polyimide panels with an organic layer in between. An AMOLED display includes an active matrix of organic light emitting diode (OLED) pixels that generate light (luminescence) upon electrical activation and that have been deposited or integrated onto a thin-film transistor (TFT) array, which functions as a series of switches to control the current flowing to each individual pixel.

In some embodiments, base layer 130 may have a thickness, measured from a top surface 132 of base layer 130 to a bottom surface 134 of base layer 130, of about 100 microns. In some embodiments, base layer 130 may have a thickness in the range of 150 microns to 25 microns, for example 125 microns to 25 microns, for example 100 microns to 25 microns, for example 75 microns to 25 microns. In some embodiments, base layer 130 may have a thickness in the range of 150 microns to 50 microns, for example 125 microns to 50 microns, for example 100 microns to 50 microns, for example 75 microns to 50 microns. In some embodiments, base layer 130 may have a thickness in the range of 125 microns to 75 microns.

Anisotropic layer 120 may be disposed over top surface 132 of base layer 130 in laminated glass article 100. In some embodiments, anisotropic layer 120 may have a thickness, measured from a top surface 122 of anisotropic layer 120 to a bottom surface 124 of anisotropic layer 120, equal to 75 microns or less. In some embodiments, anisotropic layer 120 may have thickness in the range of 75 microns to 25 microns, including subranges. In some embodiments, anisotropic layer may have a thickness of 75 microns, 70 microns, 65 microns, 60 microns, 55 microns, 50 microns, 45 microns, 40 microns, 35 microns, 30 microns, or 25 microns, or within any range having any two of these values as endpoints. In some embodiments, anisotropic layer 120 may be an orthotropic layer. In some embodiments, anisotropic layer 120 may include a plurality of stacked sub-layers.

In some embodiments, anisotropic layer 120 may be disposed directly on top surface 132 of base layer 130 (e.g., bottom surface 124 of anisotropic layer 120 may be in direct contact with top surface 132 of base layer 130.) In such embodiments, anisotropic layer 120 may be deposited or formed on top surface 132 of base layer 130. In some embodiments, anisotropic layer 120 may be adhesively attached to top surface 132 of base layer 130. In such embodiments, the adhesive bonding anisotropic layer 120 to base layer 130 is sufficiently thin (e.g., less than 20 microns) so as to not significantly affect the mechanical properties of laminated glass article 100.

Glass layer 110 may be disposed over top surface 122 of anisotropic layer 120. Glass layer 110 may be a thin glass layer. As used herein, the term “thin glass layer” means a glass layer 110 may having a thickness, measured from an outer surface 112 of glass layer 110 to an inner surface 114 of glass layer 110, in the range of 200 microns to 1.0 micron. In some embodiments, glass layer 110 may be an ultra-thin glass layer. As used herein, the term “ultra-thin glass layer” means a glass layer having a thickness in the range of 50 microns to 1.0 micron. In some embodiments, glass layer 110 may be a flexible glass layer. As used herein, a flexible layer or article is a layer or article having a bend radius, by itself, of less than or equal to 10 millimeters.

In some embodiments, glass layer 110 may have a thickness, measured from an outer surface 112 of glass layer 110 to an inner surface 114 of glass layer 110, in the range of 125 microns to 1.0 micron. In some embodiments, glass layer 110 may have a thickness in the range of 110 microns to 1.0 micron. In some embodiments, glass layer 110 may have a thickness in the range of 100 microns to 1.0 micron. In some embodiments, glass layer 110 may have a thickness in the range of 90 microns to 1.0 micron. In some embodiments, glass layer 110 may have a thickness in the range of 80 microns to 1.0 micron. In some embodiments, glass layer 110 may have a thickness in the range of 70 microns to 1.0 micron. In some embodiments, glass layer 110 may have a thickness in the range of 60 microns to 1.0 micron. In some embodiments, glass layer 110 may have a thickness in the range of 50 microns to 1.0 micron.

In some embodiments, glass layer 110 may have a thickness, measured from outer surface 112 of glass layer 110 to inner surface 114 of glass layer 110, in the range of 125 microns to 10 microns, for example 125 microns to 20 microns, or 125 microns to 30 microns, or 125 microns to 40 microns, or 125 microns to 50 microns, or 125 microns to 60 microns, or 125 microns to 70 microns, or 125 microns to 75 microns, or 125 microns to 80 microns, or 125 microns to 90 microns, or 125 microns to 100 microns. In some embodiments, glass layer 110 may have a thickness, measured from outer surface 112 of glass layer 110 to inner surface 114 of glass layer 110, in the range of 125 microns to 15 microns, for example 120 microns to 15 microns, or 110 microns to 15 microns, or 100 microns to 15 microns, or 90 microns to 15 microns, or 80 microns to 15 microns, or 70 microns to 15 microns, or 60 microns to 15 microns, or 50 microns to 15 microns, or 40 microns to 15 microns, or 30 microns to 15 microns.

In some embodiments, outer surface 112 of glass layer 110 may be an outermost, user-facing surface of laminated glass article 100. In some embodiments, glass layer 110 may be an outermost, user-facing surface of a cover substrate defined by or including laminated glass article 100. Glass layer 110 may provide desired scratch resistance for laminated glass article 100. In some embodiments, outer surface 112 may be coated with one or more coating layers to provide desired characteristics. Such coating layers include, but are not limited to, anti-reflection coating layers, easy-to-clean coating layers, and scratch resistant coating layers.

While FIG. 1 shows laminated glass article 100 as having three layers, laminated glass article 100 may include additional layers. For example, laminated glass article 100 may include four layers, five layers, six layers, or seven layers. In some embodiments, laminated glass article 100 may include a sensor layer, such as a touch senor layer that allows a user to interact with laminated glass article 100 or a display device including laminated glass article 100. Suitable touch sensor layers include, but are not limited to, a flexible touch sensor layer including CNBTM Flex Film manufactured by Canatu. In such embodiments, anisotropic layer 120 may serve to reduce stresses in the sensor layer to protect sensors within the layer from failure. In some embodiments, anisotropic layer 120 may serve to bond glass layer 110 to other layers of laminated glass article 100, for example base layer 130 and/or a sensor layer. In some embodiments, a sensor layer may be disposed between anisotropic layer 120 and base layer 130. In some embodiments, a sensor layer may be disposed between anisotropic layer 120 and glass layer 120.

Anisotropic layer 120 of laminated glass article 100 may exhibit homogenous mechanical properties as discussed herein. In some embodiments, anisotropic layer 120 may comprise homogeneous mechanical anisotropic properties measured at a certain interval. For example, in some embodiments, anisotropic layer 120 may comprise homogeneous mechanical anisotropic properties measured at intervals of 250 microns, wherein the homogeneous mechanical anisotropic properties of the anisotropic layer comprise (a) a first elastic modulus measured in a first lateral direction parallel to top surface 132 of base layer 130 (e.g., lateral direction 150 shown in FIG. 1), (b) a second elastic modulus measured in a second lateral direction parallel to top surface 132 of base layer 130 and perpendicular to the first lateral direction (e.g., lateral direction 152 shown in FIG. 1), and (c) a third elastic modulus measured in a third (vertical) direction orthogonal to top surface 132 of base layer 130 (and perpendicular to the first and second lateral directions, e.g., vertical direction 154 shown in FIG. 1), where the third elastic modulus is 100 or more times larger than each of the first elastic modulus and the second elastic modulus. In some embodiments, the interval may be larger than 250 microns, for example the interval may be 300 microns.

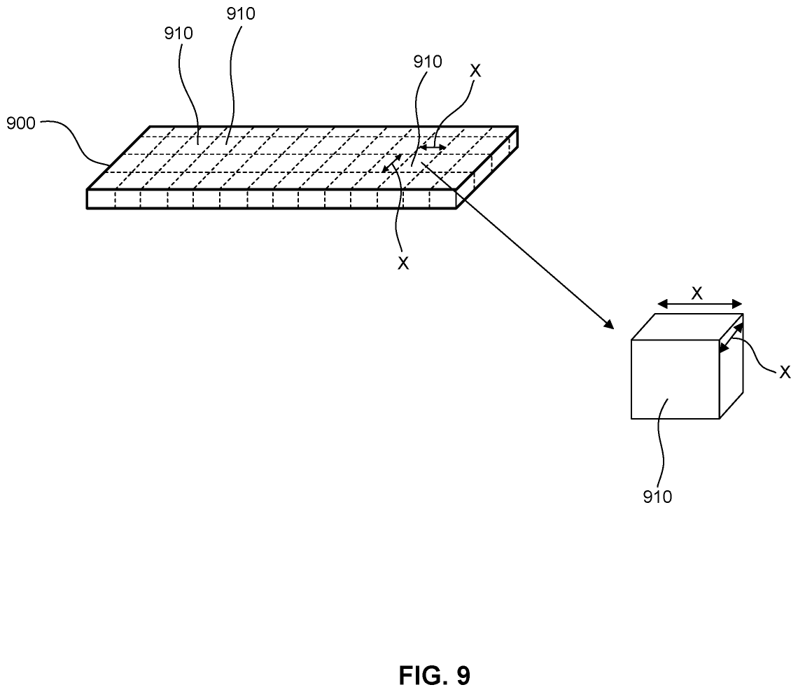

First and second lateral directions (e.g., directions 150 and 152) may be referred to as “in-plane” directions of glass article 100 and the third (vertical) direction (e.g., direction 154) may be referred to as an “out-of-plane” direction of glass article 100. FIG. 9 illustrates an exemplary anisotropic layer 900 divided into measurement intervals of X microns according to some embodiments. Anisotropic layer 900 is divided into measurement intervals by isolating blocks 910 of material having a length and width of X microns measured parallel to a top surface of the anisotropic layer 900. As illustrated in FIG. 9, the height of blocks may be equal to the thickness of anisotropic layer 900.

As discussed above, since anisotropic layer 900 exhibits homogeneous mechanical properties, each block 910 will have the same mechanical properties measured in in-plane directions (e.g., the directions in which X is measured) and in the out-of-plane direction (i.e., in the direction orthogonal to the directions in which X is measured). Unless specified otherwise, in-plane and out-of-plane directions are determined when a layer is un-deformed (i.e., before it is folded, bent, or formed into a curved shape). And, for blocks having a curved top surface, the in-plane and out-of-plane directions are determined relative to the center point of the curved surface (i.e., the point on the curved top surface of a block 910 located at the midpoint of X in both in-plane directions. Due to the size of measurement intervals discussed herein, the curvature of a block's top surface may be considered negligible.

In some embodiments, the mechanical properties of each block 910 comprise (a) a first elastic modulus measured in a first direction parallel to a top surface of anisotropic layer 900, (b) a second elastic modulus measured in a second direction parallel to the top surface of anisotropic layer 900 and perpendicular to the first direction, and (c) a third elastic modulus measured in a third direction orthogonal to the top surface of anisotropic layer 900, where the third elastic modulus is 100 or more times larger than each of the first elastic modulus and the second elastic modulus. When assembled, the first elastic modulus, the second elastic modulus, and the third elastic modulus of anisotropic layer 900 may be measured in directions parallel and orthogonal to a top surface of a base layer (e.g., top surface 132) or an inner surface of a glass layer (e.g., inner surface 114).

In some embodiments, the third elastic modulus may be 125 or more times larger than each of the first elastic modulus and the second elastic modulus. In some embodiments, the third elastic modulus may be 150 or more times larger than each of the first elastic modulus and the second elastic modulus. In some embodiments, the third elastic modulus may be 175 or more times larger than each of the first elastic modulus and the second elastic modulus. In some embodiments, the third elastic modulus may be 200 or more times larger than each of the first elastic modulus and the second elastic modulus. In some embodiments, the third elastic modulus may have a valve in the range of 100 times to 1000 times larger than each of the first elastic modulus and the second elastic modulus, including subranges. In some embodiments, the third elastic modulus may be 100 times larger than, 200 times larger than, 300 times larger than, 400 times larger than, 500 times larger than, 600 times larger than, 700 times larger than, 800 times larger than, 900 times larger than, or 1000 times larger each of the first elastic modulus and the second elastic modulus, or within any range having any two of these values as endpoints. In some embodiments, the third elastic modulus may be more than 1000 times larger than each of the first elastic modulus and the second elastic modulus.

In some embodiments, the first and second elastic modulus may be the range between 100 MPa to 0.1 MPa, for example 100 MPa to 1 MPa, or 100 MPa to 10 MPa, or 100 MPa to 20 MPa, or 100 MPa to 30 MPa, or 100 MPa to 40 MPa, or 100 MPa to 50 MPa, or 100 MPa to 60 MPa, or 100 MPa to 70 MPa, or 100 MPa to 80 MPa, or 100 MPa to 90 MPa. In some embodiments, the first elastic modulus and the second elastic modulus may be equal to or greater than 0.1 MPa. In some embodiments, the first elastic modulus and the second elastic modulus may be equal to or greater than 1 MPa. In some embodiments, the first elastic modulus and the second elastic modulus may be equal to or greater than 10 MPa. In some embodiments, the first elastic modulus and the second elastic modulus may be equal to or greater than 50 MPa. In some embodiments, the Poisson's ratio of anisotropic layer 120 measured in a first direction parallel to top surface 132 of base layer 130 and in a second direction parallel to top surface 132 of base layer 130 and perpendicular to the first direction may be in the range between 0.20 to 0.35, including subranges. In some embodiments, the Poisson's ratio measured in first and second directions may be 0.20, 0.25, 0.30, or 0.35, or within any range having any two of these values as endpoints.

In some embodiments, the third elastic modulus may be the range between 5 GPa to 1 GPa, for example 5 GPa to 2 GPa, or 5 GPa to 3 GPa, or 5 GPa to 4 GPa. In some embodiments, the third elastic modulus may be equal to or greater than 1 GPa. In some embodiments, the Poisson's ratio of anisotropic layer 120 measured orthogonal to top surface 132 of base layer 130 (and perpendicular to the first and second directions) may be in the range between 0.0001 to 0.2 including subranges. In some embodiments, the Poisson's ratio may be 0.0001, 0.001, 0.01, 0.1, or 0.2, or within any range having any two of these values as endpoints.

In some embodiments, anisotropic layer 120 may be an orthotropic layer. In such embodiments, anisotropic layer 120 may include homogeneous orthotropic mechanical properties. In such embodiments, the first elastic modulus may be equal to the second elastic modulus +/−1%. In some embodiments, the first elastic modulus may be equal to the second elastic modulus +/−0.5%. In some embodiments, the first elastic modulus may be equal to the second elastic modulus +/−1.5%. In some embodiments, the first elastic modulus may be equal to the second elastic modulus +/−2%.

In some embodiments, the refractive index of base layer 130 and the refractive index of anisotropic layer 120 may match to provide desired transparency for laminated glass article 100. In some embodiments, the difference between the refractive index of base layer 130 and the refractive index of anisotropic layer 120 may be less than or equal to 0.05. In embodiments including an anisotropic layer 120 including multiple layers or materials, the difference between the refractive index of base layer 130 and the refractive index of each layer or material of anisotropic layer 120 may be less than or equal to 0.05.

In some embodiments, laminated glass article 100 may have a bend radius of 10 millimeters or less. In some embodiments, the bend radius of laminated glass article 100 may be in the range of 10 mm to 1.0 mm, including subranges. In some embodiments, the bend radius of laminated glass article 100 may be 1.0 mm, 2.0 mm, 3.0 mm, 4.0 mm, 5.0 mm, 6.0 mm, 7.0 mm, 8.0 mm, 9.0 mm, or 10.0 mm, or within any range having any two of these values as endpoints. In some embodiments, the bend radius of laminated glass article 100 may be in the range of 5.0 mm to 1.0 mm, or in the range of 3.0 mm to 1.0 mm.

When making laminated glass article 100, anisotropic layer 120 may be disposed between top surface 134 of base layer 130 and inner surface 114 of glass layer 110. In some embodiments, anisotropic layer 120 may be disposed over top surface 134 of base layer and glass layer 110 may be disposed over anisotropic layer 120. In some embodiments, anisotropic layer 120 may be disposed over inner surface 114 of glass layer 110 and base layer 130 may be disposed over anisotropic layer 120.

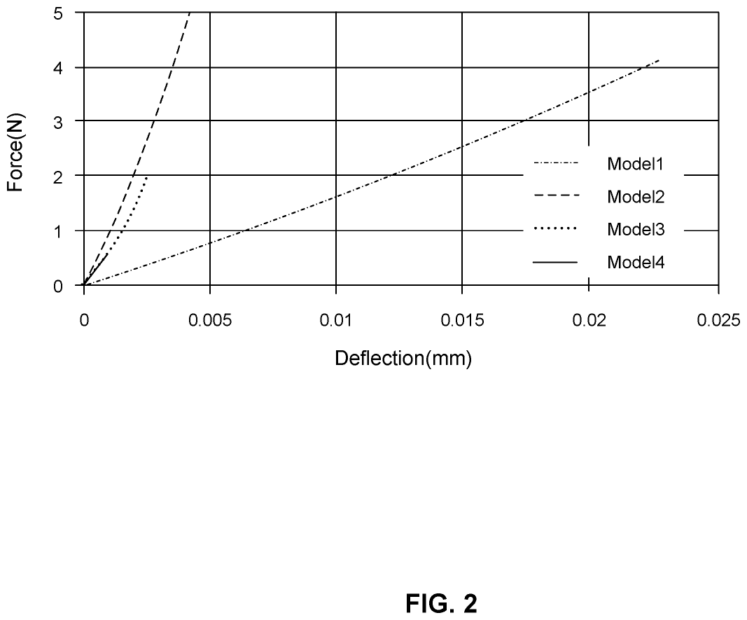

FIGS. 2-6 compare the mechanical properties of four modeled material interlayers to show how an anisotropic or orthotropic material layer can improve impact performance without sacrificing flexibility. Two model tests were created to simulate a bendable display panel during bending and puncture tests. Impact performance of a glass stack is complex due to the interaction between multiple layers, which have different material properties. High non-linearity makes impact analysis of a glass stack more complex. So, a simple puncture test in quasi-static mode was implemented to compare stresses induced under the same pen tip radius. Table 1 below shows the mechanical properties of the four modeled material layers evaluated. The three layer structure shown in FIG. 1 was used in the model tests to evaluate bending and impact (puncture) resistance of a laminated glass article. In other words, each of the four modeled material layers takes the place of anisotropic layer 120 in in laminated glass article 100 for the purpose of these modeled tests.

TABLE 1
Mechanical properties for four modeled material layers
(E = elastic modulus; v = Poisson's ratio; and G = shear modulus)

| Model | Mechanical Properties |
|---|---|
| Model 1 - Isotropic | E = 2 MPa; v = 0.49 |
| Model 2 - Isotropic | E = 2 GPa; v = 0.49 |
| Model 3 - Orthotropic | E1 = E3 = 2 MPa,E2 = 2000 MPa, |
| | G12 = G13 = G23 = 67 MPa |
| | v12 = v23 = 0.00049,v13 = 0.49 |
| Model 4 - Orthotropic | E1 = E3 = 2 MPa,E2 = 2000 MPa |
| | G12 = G13 = G23 = 6.7 MPa |
| | v12 = v23 = 0.00049,v13 = 0.49 |

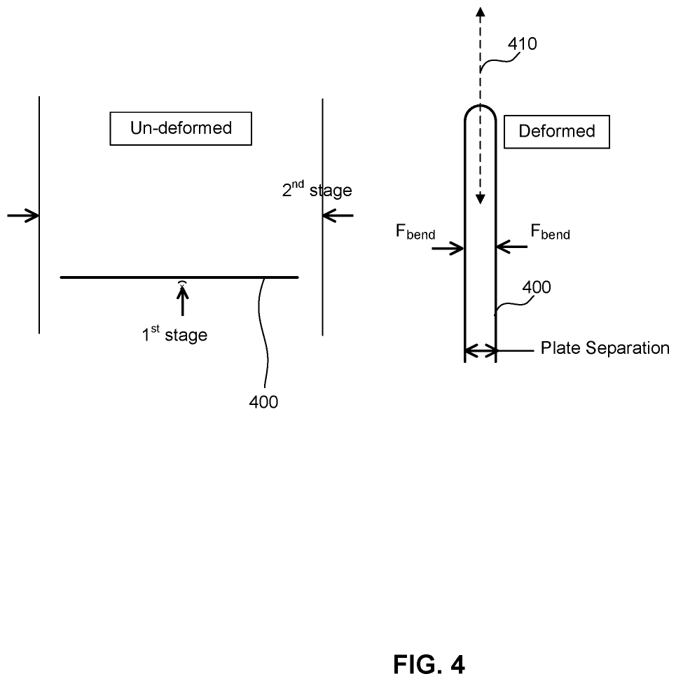

Models 1 and 2 are based on simple elastic material properties. Models 3 and 4 are based on orthotropic material properties. The orthotropic properties were selected to have higher modulus in the out of plane direction with respect to a stack (i.e., glass laminate structure shown in FIG. 1). Simultaneously, the orthotropic properties have low shearing modulus in the plane of a bending axis (e.g., axis 410 shown in FIG. 4).

FIG. 2 shows force vs. deflection of a glass stack under static indentation testing. The slope of the curve represents the stiffness of the stack. So, the higher the stiffness (slope in FIG. 2), the higher the static indentation performance and the better the pen drop performance. Although the loading conditions for the static indentation test and pen drop tests are different in the sense of static versus dynamic loading, one would generally expect that, directionally, given the characteristics and thicknesses of materials in the stack assembly, the tests are both indicative of the stack assembly's ability to absorb energy without failing. That is, a stack assembly's ability to withstand a higher static load than does another stack assembly is also generally indicative that it will withstand a higher dynamic load as well. Model 2 has the maximum stack stiffness and Model 1 has the minimum stiffness. The performance of Model 1 can be improved by stiffening the elastic constant normal to static indentation or pen drop (i.e., elastic constant “E2” in Model 3 and 4). The effect of shear modulus is also shown in FIG. 2 and Table 1. As illustrated in FIG. 2, the orthotropic materials display a high degree of stiffness approaching that of Model 2, and greater than that of Model 1.

The slope of load vs. deflection for static indentation indicates how easily a stack deforms during pen drop or static indentation. A higher slope means the glass deform less during pen drop or static indentation. Table 2 below shows a comparison of the stiffness (slope in FIG. 2) of stacks including layers of Model 1, Model 2, Model 3, and Model 4, respectively. Model 2 exhibits the highest stiffness (slope of 1200). Thus, it provides highest impact resistance. However, orthotropic Models 3 and 4 exhibit significantly higher stiffness (slopes of 784 and 628, respectively), and thus impact resistance, than isotropic Model 1 (slope of 179).

TABLE 2
Slope of Load vs. Deflection Response

| Model | Slope of Load vs. Deflection |
|---|---|
| Model 1 | 179 |
| Model 2 | 1200 |
| Model 3 | 784 |
| Model 4 | 628 |

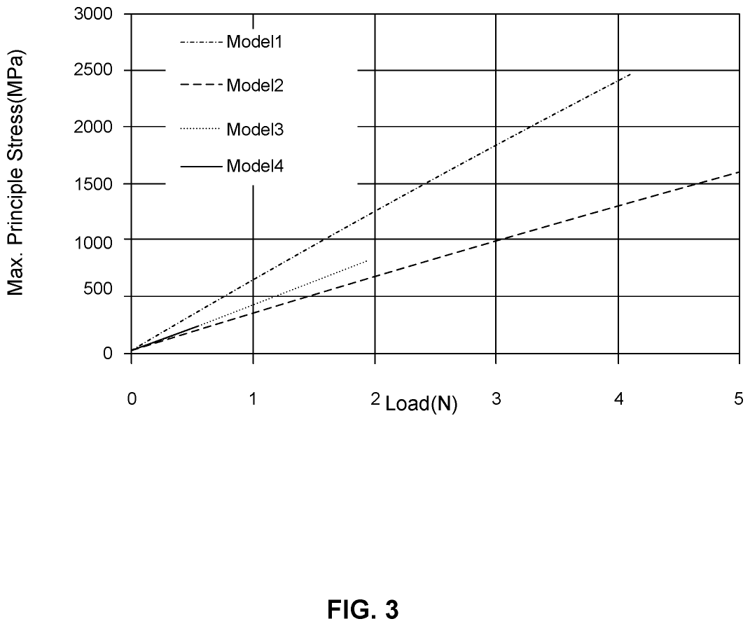

FIG. 3 shows the maximum principle stress on the inner surface of the glass layer in a stack (i.e., inner surface 114 of glass layer 110) verses load during static indentation, wherein the static indentation is performed with the load pressing down onto surface 112, as shown in FIG. 1). FIG. 3 shows that by making an interlayer within the stack an orthotropic material the stress in the glass layer can be reduced for a given load (compare Model 1 (isotropic) to Models 3 and 4 (both orthotropic)), wherein for a given load (for example 1N) Model 3 has a lower maximum principle stress than does Model 1. So, a glass layer can handle higher static indentation loading and, similarly, higher drop height when supported by an orthotropic material as opposed to an isotropic material. In other words, the stiffness of a stack increases when a glass layer is supported by an orthotropic layer having a larger out of plane elastic modulus than the elastic modulus of an isotropic material.

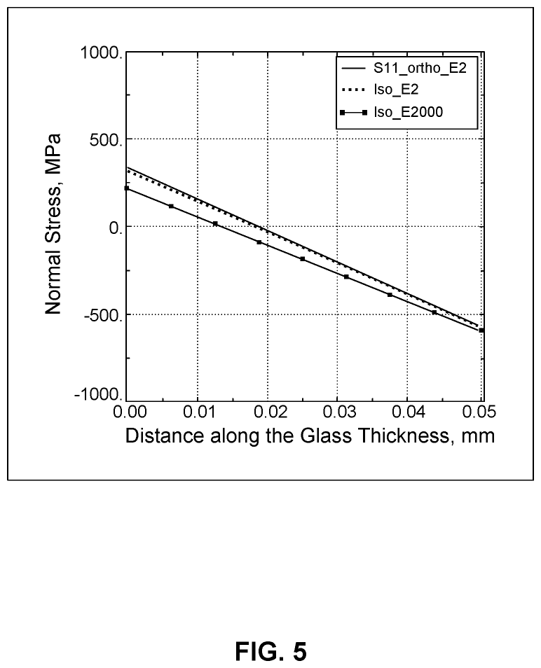

FIG. 4 shows the bending model test details. The model shown in FIG. 4 was created to simulate the two-point bend test of a foldable display stack 400 having a three layer structure as discussed in regards to FIG. 1. FIG. 5 shows the tensile normal stress in the glass layer of the stack as function of thickness. Normal stress refers to the directional-dependent stress, i.e., the stress in x-direction or y-direction in a glass layer (e.g., the stress in directions 150 and 152 in FIG. 1). In FIG. 5, “S11_ortho_E2” represents Models 3 and 4, “Iso_E2” represents Model 1 (low stiffness), and “Iso_E2000” represents Model 2 (high stiffness). As shown in FIG. 5, stresses in a glass layer of stack having an orthotropic layer are comparable to those with an isotropic layer. And an isotropic material with E=2000 MPa (high stiffness) yielded lower stresses, as compared to a material with lower stiffness.

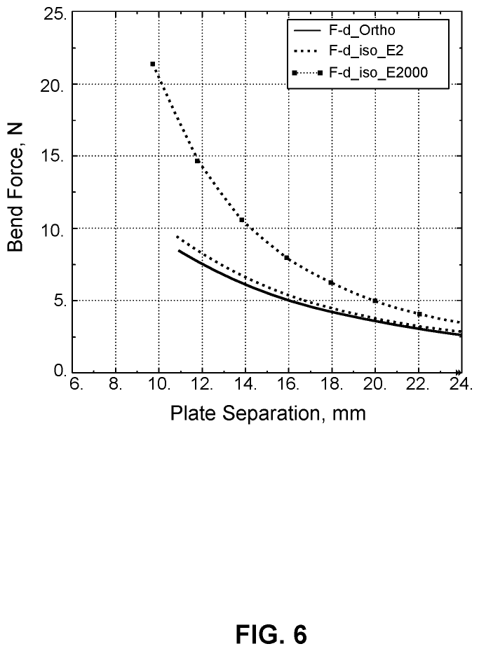

FIG. 6 shows the bend force for a display stack as a function of plate separation (which is related to bend radius). In FIG. 6, “F-d_Ortho” represents Models 3 and 4, “F-d_iso_E2” represents Model 1 (low stiffness), and “F-d_iso_E2000” represents Model 2 (high stiffness). As illustrated in FIG. 6, the bend force for a stack having an orthotropic layer is slightly lower than the ones with an isotropic layer having similar in-plane stiffness. For an isotropic layer having E=2000 MPa in all directions (high stiffness), the bend force at smaller plate separation distances (e.g., less than 11 mm) will be about 3 times higher than one with orthotropic property.

As such, FIGS. 2-6 illustrate how an orthotropic layer can improve the puncture or impact resistance of a glass stack while also providing a stack with a high degree of flexibility. Models 3 and 4 provide improved impact resistance compared to isotropic Model 1 having elastic moduli equal to the in-plane elastic moduli of Models 3 and 4. And Models 3 and 4 showed increased flexibility compared to isotropic Model 2, and flexibility comparable to Model 1. An anisotropic material with similar elastic moduli values as orthotropic Models 3 and 4 may improve impact resistance of a glass stack without sacrificing flexibility in the same manner as orthotropic Models 3 and 4.

Returning to FIG. 1, anisotropic layer 120 may include one or more anisotropic or orthotropic material layers, including but not limited to, anisotropic or orthotropic polymeric materials, magnetic fluids or shear thickening fluids, interpenetrating polymer networks (IPN), composite materials, structured films, such as micro-replicated films, molecular self-assemblies, and tentered materials. In some embodiments, anisotropic layer 120 may be a multi-layer film including layers having different mechanical properties (e.g., modulus and stress/strain properties).

Polymeric Material(s)—Polymers that contain the ability to crystalize can display anisotropic or orthotropic properties. Control of the crystalline structure through heat treatment and/or controlled application of stresses during manufacturing allows one to change the mechanical properties of the material in its final form. By controlling the crystalline structure of a crystalline polymer, crack propagation through the polymer can be controlled. Propagating cracks will generally follow the crystalline structure in an anisotropic or orthotropic material. In addition, the direction that the material is loaded or stressed in relation to the orientation angle between a load and the extrusion direction of a crystalline polymer may have a large effect on whether or not a crack can be formed, and the rate of crack propagation once a crack is initiated.

Magnetic Fluids or Shear Thickening Fluids—Shear thickening fluids have dynamic mechanical properties based on the amount of shear that is applied to the fluid. A common example of this is cornstarch mixed with water. These fluids are sometimes found in shock absorbers for vehicles. Magnetic fluids (magneto-rheological fluids) are another set of materials that have mechanical properties that can be altered to produce desired anisotropic or orthotropic mechanical properties. Magneto-rheological fluids manufactured by LORD Corporation are one example of suitable fluids that can exhibit anisotropic or orthotropic mechanical properties.

Interpenetrating polymer networks (IPN) or Composite Materials—These materials allow for anisotropic or orthotropic properties if designed correctly. For example, fiber reinforced polymers can exhibit anisotropic or orthotropic mechanical properties by tailoring the orientation of fibers within the polymer. Examples of composite materials include, but are not limited to, polymeric composite materials, for example IPNs, vinyl ester/polyurethane reinforced with fibers, and epoxy reinforced with graphite fibers.

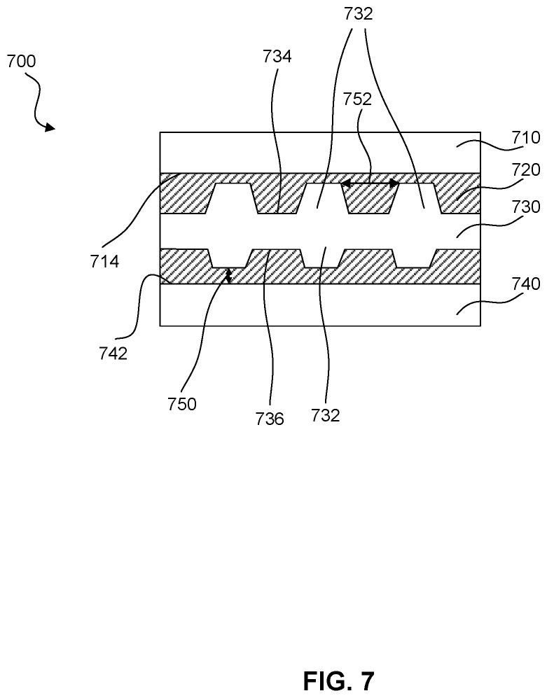

Structured Films—Micro-replicated films (micro-structured films) can be designed to exhibit anisotropic or orthotropic properties. FIG. 7 shows a laminated glass article 700 including an anisotropic layer including a micro-structured film 730 according to some embodiments. Similar to laminated glass article 100, laminated glass article 700 may include a glass layer 710 and a base layer 740. Glass layer 710 may be the same as or similar to glass layer 110 and base layer 740 may be the same as or similar to base layer 130.

Micro-structured film 730 includes a plurality of micro-structured surface features 732 disposed on a top surface 734 and/or a bottom surface 736 of film 730. Micro-structured features 732 may include features having at least one lateral dimension, measured parallel to top surface 734 or bottom surface 736, having a maximum value of less than or equal to 100 microns. In some embodiments, the at least one lateral dimension may be measured relative to a top surface 742 of base layer 740 or an inner surface 714 of glass layer 710. In some embodiments, neighboring micro-structured features 732 may be separated from each other by a maximum distance 752 of 200 microns or less. As used herein, “neighboring micro-structured features” means two micro-structured features disposed adjacent to each other with no intervening micro-structured features disposed between them.

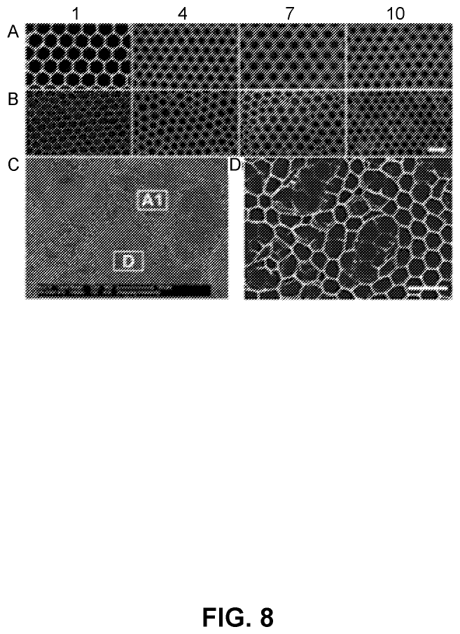

In some embodiments, micro-structured features 732 may be protrusions extending from one or more surfaces of micro-structured film 730. Micro-structured features 732 protruding from surface of micro-structured film 730 may include, but are not limited to square shaped features, trapezoidal shaped features, and honeycomb shaped features. In some embodiments, the medium that includes these micro-features may be porous with interconnected channels. In some embodiments, micro-structured features 732 may be grooves, channels, or recesses formed in one or more surfaces of micro-structured film 730. For example, micro-structured features 732 may be honeycomb shaped recesses as shown in FIG. 8.

In some embodiments, micro-structured film 730 may be bonded to base layer 740 and/or glass layer 710 with an adhesive 720. Adhesive 720 may be, but is not limited to a pressure sensitive adhesive, an epoxy, an optically clear adhesive (OCA), a urethane adhesive, or a silicone adhesive. In some embodiments, micro-structured film 730 may be encapsulated between base layer 740 and glass layer 710. In such embodiments, no portion of micro-structured film 730 may contact base layer 740 or glass layer 710. And in such embodiments, surface features 732 on either side of micro-structured film 730 may be spaced from base layer 740 and glass layer 710, respectively, by less than or equal to a maximum distance 750. Maximum distance 750 may be sufficiently small such that adhesive 720 does not significantly affect the mechanical properties of laminated glass article 700.

A sufficiently small maximum distance 750 results in minimal compression of adhesive 720 before glass layer 710 and/or base layer 740 are compressed with micro-structured film 730 to form a rigid system when compression or impact stresses are placed on micro-structured film 730 in the out-of-plane direction. However, in flexure this configuration will allow for micro-structured film 730 to flex in the areas where micro-structured film 730 is thinnest (i.e., at locations between micro-structured features 732). In some embodiments, maximum distance 750 may be 20 microns. In some embodiments, maximum distance 750 may be 15 microns.

Micro-structured features 732 control properties of micro-structured film 730 in the out-of-plane direction and the in-plane directions. The size and spacing of micro-structured features 732 produce a film having anisotropic or orthotropic mechanical properties, and the size and spacing may be tailored to provide desired anisotropic or orthotropic mechanical properties.

In some embodiments, micro-structured film 730 may be a polymeric micro-structured film, for example a PET micro-structured film or a polystyrene micro-structured film. In some embodiments, micro-structured film 730 may comprise a material having a relatively high elastic modulus, for example an elastic modulus of equal to or greater than 1.0 MPa. In some embodiments, micro-structured film 730 may comprise a material having an elastic modulus in the range of 1.0 MPa to 2.5 GPa, including subranges. In some embodiments, the elastic modulus may be 1.0 MPa, 50 MPa, 100 MPa, 200 MPa, 300 MPa, 400 MPa, 500 MPa, 600 MPa, 700 MPa, 800 MPa, 900 MPa, 1.0 GPa, 1.5 GPa, 2.0 GPa, or 2.5 GPa, or within any range having any two of these values as endpoints.

In some embodiments, micro-structured film 730 may include a self-assembled molecular assembly including patterned micro-structured features 732. FIG. 8 illustrates self-assembled core cross-linked star (CCS) polystyrene (PS) microstructures formed in a honeycomb pattern according to some embodiments. FIG. 8 illustrates SEM images of honeycomb films prepared from (A) CCS-(PS)₈-cyl and (B) CCS-(PS)₈-neu with M_{n(PS)}=2960 g mol⁻¹ at different concentrations ranging from 1, 4, 7, and 10 mg mL⁻1. (C and D) SEM images prepared from CCS-(PS)₈-cyl at 1 mg mL⁻¹. The scale of FIG. 8 is 5 microns.

Multilayered Films—Multi-layered films may inherently exhibit anisotropic or orthotropic mechanical properties due to differences in the modulus, stress/strain, etc. properties found in the different layers. A multilayered structure including polypropylene homopolymer/ethylene 1-octene copolymer sheets is one example of a suitable multilayer material that exhibits anisotropic or orthotropic mechanical properties. In some embodiments, a change in the crystalline structure between different films in a multilayered film may create desired anisotropic or orthotropic mechanical properties.

Tentered Materials—Exemplary tentered materials include, but are not limited to, tentered polypropylene (PP) films and biaxially oriented polypropylene (BOPP) films. By controlling the orientation of films throughout the tentering process, a manufacturer may change several properties within a film. For example, the hardness, elastic modulus, tensile strength for a given thickness, stiffness, optical properties, fracture mechanics, tear properties, and/or water/gas permeability may be tailored to create a tentered film having desired properties. In some embodiments, tentering a film may control the crystalline structure found within the film. Simultaneous or sequential stretching of films has been demonstrated to have a profound effect on the resulting film properties. The resulting properties are normally measured in the machine direction (MD) or trans direction (TD). When processing a tentered material, the machine direction is the direction in which the material moves during processing. This direction is usually the direction in which the length or width of a material is measured (e.g., first lateral direction 150 or second lateral direction 152 shown in FIG. 1). In embodiments including roll-to-roll processing the machine direction may be the circumferential direction of a roll onto which the material is rolled. The tans direction (also called the “cross direction”) is the direction perpendicular to and on the same plane as the direction in which the material moves during processing. This direction is also usually the direction in which the length or width of the material is measured (e.g., first lateral direction 150 or second lateral direction 152 shown in FIG. 1). The tensile strength, the elongation at break, and the elastic modulus for a tentered material may be different in the TD and MD directions to produce an anisotropic or orthotropic material film.

In each of the above examples, the anisotropic or orthotropic layer may exhibit homogeneous mechanical properties when measured at intervals of X microns, for example 250 microns or 300 microns. FIG. 9 shows an exemplary anisotropic layer 900 divided into measurement intervals of X microns according to some embodiments.

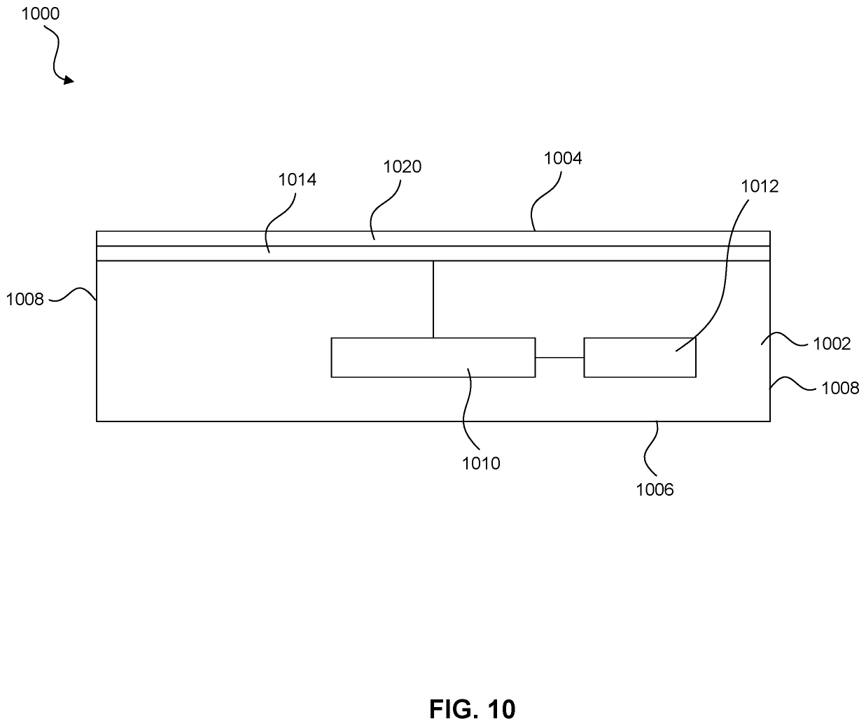

FIG. 10 shows a consumer electronic product 1000 according to some embodiments. Consumer electronic product 1000 may include a housing 1002 having a front (user-facing) surface 1004, a back surface 1006, and side surfaces 1008. Electrical components may be at least partially within housing 1002. The electrical components may include, among others, a controller 1010, a memory 1012, and display components, including a display 1014. In some embodiments, display 1014 may be at or adjacent to front surface 1004 of housing 1002.

As shown for example in FIG. 10, consumer electronic product 1000 may include a cover substrate 1020. Cover substrate 1020 may serve to protect display 1014 and other components of electronic product 1000 (e.g., controller 1010 and memory 1012) from damage. In some embodiments, cover substrate 1020 may be disposed over display 1014. In some embodiments, cover substrate 1020 may be a cover glass defined in whole or in part by a laminated glass article discussed herein. Cover substrate 1020 may be a 2D, 2.5D, or 3D cover substrate. In some embodiments, cover substrate 1020 may define front surface 1004 of housing 1002. In some embodiments, cover substrate 1020 may define front surface 1004 of housing 1002 and all or a portion of side surfaces 1008 of housing 1002. In some embodiments, consumer electronic product 1000 may include a cover substrate defining all or a portion of back surface 1006 of housing 1002.

As used herein the term “glass” is meant to include any material made at least partially of glass, including glass and glass-ceramics. “Glass-ceramics” include materials produced through controlled crystallization of glass. In embodiments, glass-ceramics have about 30% to about 90% crystallinity. Non-limiting examples of glass ceramic systems that may be used include Li₂O×Al₂O₃×nSiO₂ (i.e. LAS system), MgO×Al₂O₃×nSiO₂ (i.e. MAS system), and ZnO×Al₂O₃×nSiO₂ (i.e. ZAS system).

In one or more embodiments, the amorphous substrate may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of Lithia. In one or more alternative embodiments, the substrate may include crystalline substrates such as glass ceramic substrates (which may be strengthened or non-strengthened) or may include a single crystal structure, such as sapphire. In one or more specific embodiments, the substrate includes an amorphous base (e.g., glass) and a crystalline cladding (e.g., sapphire layer, a polycrystalline alumina layer and/or or a spinel (MgAl₂O₄) layer).

A substrate may be strengthened to form a strengthened substrate. As used herein, the term “strengthened substrate” may refer to a substrate that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

Where the substrate is chemically strengthened by an ion exchange process, the ions in the surface layer of the substrate are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate in a salt bath (or baths), use of multiple salt baths, additional steps such as annealing, washing, and the like, are generally determined by the composition of the substrate and the desired compressive stress (CS), depth of compression (or DOC, where the stress changes from tensile to compressive) of the substrate that result from the strengthening operation. By way of example, ion exchange of alkali metal-containing glass substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath is diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

As discussed herein, a glass layer be coated with one or more coating layers to provide desired characteristics. In some embodiments, multiple coating layers, of the same or different types, may be coated on a glass layer.

Exemplary materials used in a scratch resistant coating layer may include an inorganic carbide, nitride, oxide, diamond-like material, or a combination thereof. In some embodiments, the scratch resistant coating layer may include a multilayer structure of aluminum oxynitride (AlON) and silicon dioxide (SiO₂). In some embodiments, the scratch resistant coating layer may include a metal oxide layer, a metal nitride layer, a metal carbide layer, a metal boride layer or a diamond-like carbon layer. Example metals for such an oxide, nitride, carbide or boride layer include boron, aluminum, silicon, titanium, vanadium, chromium, yttrium, zirconium, niobium, molybdenum, tin, hafnium, tantalum, and tungsten. In some embodiments, the coating layer may include an inorganic material. Non-limiting example inorganic layers include aluminum oxide and zirconium oxide layers.

In some embodiments, the scratch resistant coating layer may include a scratch resistant coating layer as described in U.S. Pat. No. 9,328,016, issued on May 3, 2016, which is hereby incorporated by reference in its entirety by reference thereto. In some embodiments, the scratch resistant coating layer may include a silicon-containing oxide, a silicon-containing nitride, an aluminum-containing nitride (e.g., AlN and AlₓSi_{y}N), an aluminum-containing oxy-nitride (e.g., AlOₓN_{y} and SiᵤAlₓOₓN_{y}), an aluminum-containing oxide or combinations thereof. In some embodiments, the scratch resistant coating layer may include transparent dielectric materials such as SiO₂, GeO₂, Al₂O₃, Nb₂O₅, TiO₂, Y₂O₃ and other similar materials and combinations thereof. In some embodiments, the scratch resistant coating layer may include a scratch resistant coating layer as described in U.S. Pat. No. 9,110,230, issued on Aug. 18, 2015, which is hereby incorporated by reference in its entirety by reference thereto. In some embodiments, the scratch resistant coating layer may include one or more of AlN, Si₃N₄, AlOₓN_{y}, SiOₓN_{y}, Al₂O₃, SiₓC_{y}, SiₓO_{y}C_{z}, ZrO₂, TiOₓN_{y}, diamond, diamond-like carbon, and SiᵤAlᵥOₓN_{y}. In some embodiments, the scratch resistant coating layer may include a scratch resistant coating layer as described in U.S. Pat. No. 9,359,261, issued on Jun. 7, 2016, or U.S. Pat. No. 9,335,444, issued on May 10, 2016, both of which are hereby incorporated by reference in their entirety by reference thereto.

In some embodiments, a coating layer may be an anti-reflective coating layer. Exemplary materials suitable for use in the anti-reflective coating layer include: SiO₂, Al₂O₃, GeO₂, SiO, AlOₓN_{y}, AlN, SiNₓ, SiOₓN_{y}, SiᵤAlᵥOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, and other materials cited above as suitable for use in a scratch resistant layer. An anti-reflection coating layer may include sub-layers of different materials.

In some embodiments, the anti-reflection coating layer may include a hexagonally packed nanoparticle layer, for example but not limited to, the hexagonally packed nanoparticle layers described in U.S. Pat. No. 9,272,947, issued Mar. 1, 2016, which is hereby incorporated by reference in its entirety by reference thereto In some embodiments, the anti-reflection coating layer may include a nanoporous Si-containing coating layer, for example but not limited to the nanoporous Si-containing coating layers described in WO2013/106629, published on Jul. 18, 2013, which is hereby incorporated by reference in its entirety by reference thereto. In some embodiments, the anti-reflection coating may include a multilayer coating, for example, but not limited to the multilayer coatings described in WO2013/106638, published on Jul. 18, 2013; WO2013/082488, published on Jun. 6, 2013; and U.S. Pat. No. 9,335,444, issued on May 10, 2016, all of which are hereby incorporated by reference in their entirety by reference thereto.

In some embodiments, a coating layer may be an easy-to-clean coating layer. In some embodiments, the easy-to-clean coating layer may include a material selected from the group consisting of fluoroalkylsilanes, perfluoropolyether alkoxy silanes, perfluoroalkyl alkoxy silanes, fluoroalkylsilane-(non-fluoroalkylsilane) copolymers, and mixtures of fluoroalkylsilanes. In some embodiments, the easy-to-clean coating layer may include one or more materials that are silanes of selected types containing perfluorinated groups, for example, perfluoroalkyl silanes of formula (R_{F})_{y}Si_{X4-y}, where RF is a linear C6-C₃₀ perfluoroalkyl group, X=CI, acetoxy, —OCH₃, and —OCH₂CH₃, and y=2 or 3. The perfluoroalkyl silanes can be obtained commercially from many vendors including Dow-Corning (for example fluorocarbons 2604 and 2634), 3MCompany (for example ECC-1000 and ECC-4000), and other fluorocarbon suppliers such as Daikin Corporation, Ceko (South Korea), Cotec-GmbH (DURALON UltraTec materials) and Evonik. In some embodiments, the easy-to-clean coating layer may include an easy-to-clean coating layer as described in WO2013/082477, published on Jun. 6, 2013, which is hereby incorporated by reference in its entirety by reference thereto.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The term “or,” as used herein, is inclusive; more specifically, the phrase “A or B” means “A, B, or both A and B.” Exclusive “or” is designated herein by terms such as “either A or B” and “one of A or B,” for example.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

As used in the claims, “comprising” is an open-ended transitional phrase. A list of elements following the transitional phrase “comprising” is a non-exclusive list, such that elements in addition to those specifically recited in the list may also be present. As used in the claims, “consisting essentially of” or “composed essentially of” limits the composition of a material to the specified materials and those that do not materially affect the basic and novel characteristic(s) of the material. As used in the claims, “consisting of” or “composed entirely of” limits the composition of a material to the specified materials and excludes any material not specified.

The term “wherein” is used as an open-ended transitional phrase, to introduce a recitation of a series of characteristics of the structure.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made with reference to the figures as drawn and are not intended to imply absolute orientation.

The present embodiment(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

1. A laminated glass article comprising:
a base layer comprising a top surface and a bottom surface;
an anisotropic layer disposed over the top surface of the base layer, the anisotropic layer comprising homogeneous mechanical anisotropic properties measured at intervals of 250 microns, wherein the homogeneous mechanical anisotropic properties of the anisotropic layer comprise:
a first elastic modulus measured in a first direction parallel to the top surface of the base layer,
a second elastic modulus measured in a second direction parallel to the top surface of the base layer and perpendicular to the first direction, and
a third elastic modulus measured in a third direction orthogonal to the top surface of the base layer, wherein the third elastic modulus is 100 or more times larger than each of the first elastic modulus and the second elastic modulus; and
a glass layer disposed over the anisotropic layer.

2. The laminated glass article of claim 1, wherein the anisotropic layer comprises homogeneous orthotropic mechanical properties, and wherein the first elastic modulus is equal to the second elastic modulus +/−1%.

3. The laminated glass article of claim 1, wherein the glass layer has a thickness in the range of 125 microns to 1 micron.

4. The laminated glass article of claim 1, wherein the anisotropic layer has a thickness in the range of 75 microns to 25 microns.

5. The laminated glass article of claim 1, wherein a difference between a refractive index of the base layer and a refractive index of the anisotropic layer is less than or equal to 0.05.

6. The laminated glass article of claim 1, wherein the laminated glass article has a bend radius of 10 millimeters or less.

7. The laminated glass article of claim 1, wherein the anisotropic layer comprises a plurality of stacked sub-layers.

8. The laminated glass article of claim 1, wherein the anisotropic layer comprises a micro-structured film encapsulated by an adhesive.

9. The laminated glass article of claim 8, wherein the micro-structured film comprises a plurality of surface features disposed on a surface of the micro-structured film.

10. The laminated glass article of claim 9, wherein the surface features are micro-features comprising at least one dimension of 100 microns or less, the at least one dimension being measured in a direction parallel to the top surface of the base layer.

11. The laminated glass article of claim 1, wherein the base layer comprises a flexible base layer having a bend radius less than or equal to 10 millimeters.

12. The laminated glass article of claim 1, wherein the anisotropic layer comprises a polymeric material, a composite polymeric material, or a tentered material.

13. The laminated glass article of claim 1, wherein the anisotropic layer comprises a self-assembled molecular assembly comprising patterned features, wherein the patterned features comprise a least one dimension of 100 microns or less measured in a direction parallel to the top surface of the base layer.

14. A method of making a laminated glass article, the method comprising:
disposing an anisotropic layer over a top surface of a base layer, the anisotropic layer comprising homogeneous mechanical anisotropic properties measured at intervals of 250 microns, wherein the homogeneous mechanical anisotropic properties of the anisotropic layer comprise:
a first elastic modulus measured in a first direction parallel to the top surface of the base layer,
a second elastic modulus measured in a second direction parallel to the top surface of the base layer and perpendicular to the first direction, and
a third elastic modulus measured in a third direction orthogonal to the top surface of the base layer, wherein the third elastic modulus is 100 or more times larger than each of the first elastic modulus and the second elastic modulus; and
disposing a glass layer over the anisotropic layer.

15. The method of claim 14, wherein the first elastic modulus is equal to the second elastic modulus +/−1%.

16. The method of claim 14, wherein a difference between a refractive index of the base layer and a refractive index of the anisotropic layer is less than or equal to 0.05.

17. An article comprising:
a cover substrate comprising:
a base layer comprising a top surface and a bottom surface;
an anisotropic layer disposed over the top surface of the base layer, the anisotropic layer comprising homogeneous mechanical anisotropic properties measured at intervals of 250 microns, wherein the homogeneous mechanical anisotropic properties of the anisotropic layer comprise:
a first elastic modulus measured in a first direction parallel to the top surface of the base layer,
a second elastic modulus measured in a second direction parallel to the top surface of the base layer and perpendicular to the first direction, and
a third elastic modulus measured in a third direction orthogonal to the top surface of the base layer, wherein the third elastic modulus is 100 or more times larger than the first elastic modulus and the second elastic modulus; and
a glass layer disposed over the anisotropic layer.

18. The article of claim 17, wherein the article is a consumer electronic product, the consumer electronic product comprising:
a housing comprising a front surface, a back surface and side surfaces;
electrical components at least partially within the housing, the electrical components comprising at least a controller, a memory, and a display, the display proximate or adjacent the front surface of the housing; and
the cover substrate, wherein the cover substrate is disposed over the display or comprises a portion of the housing.
